(19) United States
(12) Patent Application Publication
(10) Pub. No.: US 2010/0124854 A1
(43) Pub. Date: May 20, 2010

(54) Structure for improving the voltage difference of a connector

(76) Inventor: TING-PAN LIU, HSINCHUANG CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,295

(22) Filed: Nov. 17, 2008

(51) Int. Cl. H01R 24/00

(52) U.S. Cl. 439/676

(57) ABSTRACT

A structure for improving the voltage difference of a connector includes a communication connector, an enclosure, and a conducting gasket. The communication connector is assembled with the enclosure. The conducting gasket is located and conducted at the connection area of the communication connector and the enclosure. Thereby, the conductivity of the communication connector and the enclosure is increased and the voltage difference is improved. Furthermore the connector does not require traditional manual welding for connection; thereby manufacturing time and cost are reduced.

### BACKGROUND OF THE INVENTION

1. Field of the Invention

The present invention relates to a structure for improving the voltage difference of a connector; in particular, the present invention relates to a structure for improving the voltage difference of a connector that improves the conductivity of a communication connector and an enclosure so as to improve the voltage difference.

2. Description of Related Art

A communication connector and an enclosure (or named as tuner, can, RF can, iron shell, or lower cover) are conventionally assembled by riveting or soldering. Because the communication connector and the enclosure are independently formed, there is a tiny gap on the contacting surface when the communication connector and the enclosure are assembled. Therefore, the voltage difference generates an increase of electromagnetic interference (EMI).

Conventionally, the voltage difference is improved by manually soldering the riveting area. A worker needs to use both hands to respectively hold the tin and the soldering iron, so as to melt the tin to fasten the connector and the enclosure.

However, the manual soldering method has the following drawbacks.

1. Comparatively more manpower is necessary if the manual soldering method is required. The assembly speed is slow, the cost is high.

2. When the soldering operation is performed and the worker needs to rotate the communication connector and the enclosure to change the soldering direction and location, the required soldering time and manpower is further prolonged.

3. The fake-solder symptom may occur due to the human factor of carelessness, inferior skill, or the tin being not smoothly pulled.

4. Due to worker operation mistake, it is easy to make the high temperature soldering iron contact the surface of the communication connector and the enclosure thereby damage the surface electroplating layer of the communication connector and the enclosure. Therefore, the appearance is of the product is damaged and the quality is lowered due to oxidizing.

5. Due to worker operation mistake, it is easy to make the soldering material be stained on the connection pin of the communication connector. Thereby noise may be generated or short-circuit may occur.

6. Due to worker operation mistake, it is easy to make soldering flux be carbonized to affect the appearance. Moreover, the carbonized material may flake off to cause other electronic components be short-circuited.

### SUMMARY OF THE INVENTION

One particular aspect of the present invention is to provide a structure for improving the voltage difference of a connector that overcomes the drawbacks of the connector being assembled by the traditional manual soldering, thereby reduces the manpower and the working time to lower the assembly time, and improves the yield rate.

The structure for improving the voltage difference of a connector includes a communication connector, an enclosure, and a conducting gasket. The communication connector is assembled with the enclosure. The conducting gasket is located and conducted at the connection area of the communication connector and the enclosure.

The present invention has the following characteristics:

1. The conductivity and the voltage difference of the communication connector and the enclosure are improved.

2. The manufacturing time is reduced to lower the manufacturing cost.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a schematic diagram of a structure for improving the voltage difference of a connector of the first embodiment of the present invention before being assembled;

FIG. 2 is a schematic diagram of the structure for improving the voltage difference of the connector of the first embodiment of the present invention after being assembled;

FIG. 3 is a schematic diagram of the structure for improving the voltage difference of a connector of the second embodiment of the present invention before being assembled;

FIG. 4 is a schematic diagram of the structure for improving the voltage difference of the connector of the second embodiment of the present invention after being assembled;

FIG. 5 is a schematic diagram of the structure for improving the voltage difference of a connector of the third embodiment of the present invention before being assembled;

FIG. 6 is a schematic diagram of the structure for improving the voltage difference of the connector of the third embodiment of the present invention after being assembled;

FIG. 7 is a schematic diagram of the structure for improving the voltage difference of a connector of the fourth embodiment of the present invention before being assembled;

FIG. 8 is a schematic diagram of the structure for improving the voltage difference of the connector of the fourth embodiment of the present invention after being assembled;

FIG. 9 is a schematic diagram of the structure for improving the voltage difference of a connector of the fifth embodiment of the present invention before being assembled;

FIG. 10 is a schematic diagram of the structure for improving the voltage difference of the connector of the fifth embodiment of the present invention after being assembled;

FIG. 11 is a schematic diagram of the structure for improving the voltage difference of a connector of the sixth embodiment of the present invention after being assembled;

FIG. 12 is a schematic diagram of the structure for improving the voltage difference of a connector of the seventh embodiment of the present invention after being assembled;

FIG. 13 is a schematic diagram of the structure for improving the voltage difference of a connector of the eighth embodiment of the present invention after being assembled;

FIG. 14 is a schematic diagram of the structure for improving the voltage difference of a connector of the ninth embodiment of the present invention after being assembled;

FIG. 15 is a schematic diagram of the structure for improving the voltage difference of a connector of the tenth embodiment of the present invention after being assembled;

FIG. 16 is a schematic diagram of the structure for improving the voltage difference of a connector of the eleventh embodiment of the present invention after being assembled;

FIG. 17 is a schematic diagram of the structure for improving the voltage difference of a connector of the twelfth embodiment of the present invention after being assembled;

FIG. 18 is a schematic diagram of the structure for improving the voltage difference of a connector of the thirteenth embodiment of the present invention after being assembled;

FIG. 19 is a schematic diagram of the structure for improving the voltage difference of a connector of the fourteenth embodiment of the present invention after being assembled;

FIG. 20 is a schematic diagram of the structure for improving the voltage difference of a connector of the fifteenth embodiment of the present invention after being assembled; and

FIGS. 21A˜21G are schematic diagrams respectively of a conducting element of the present invention.

### DETAILED DESCRIPTION OF PREFERRED EMBODIMENTS

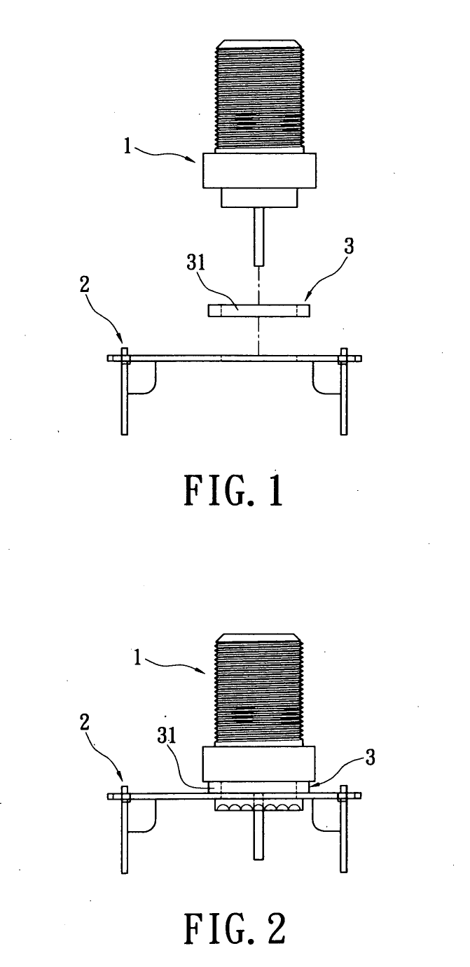

Reference is made to FIGS. 1-4. The structure for improving the voltage difference of a connector of the present invention includes a communication connector 1, an enclosure 2, and a conducting element 3. The type of the communication connector 1 is not limited to a specific one. The communication connector 1 can be an F connector manufactured by turning or free-cutting, a PAL connector manufactured by turning, free-cutting, pipe-cutting, or deep-drawing, or other connector. The enclosure 2 is a metallic frame. The enclosure 2 is assembled with communication connector 1.

The conducting element 3 is a conductive metal or material, such as copper, aluminum, tin, iron, tin-strip, conducting gasket, or conductive glue, etc. In this embodiment, the conductive element 3 is a non-sticky conductive gasket 31. The conductive gasket 31 is a conductive metal or material and is non-sticky. The shape of the raw material can be flake-shaped, strip-shaped, board-shaped, roll-shaped, etc. The raw material is formed into a conductive gasket 31 by using a forming tool (traditional, airing, or pressuring), a slide forming or a rolling-knife punching tool, and a forming mold.

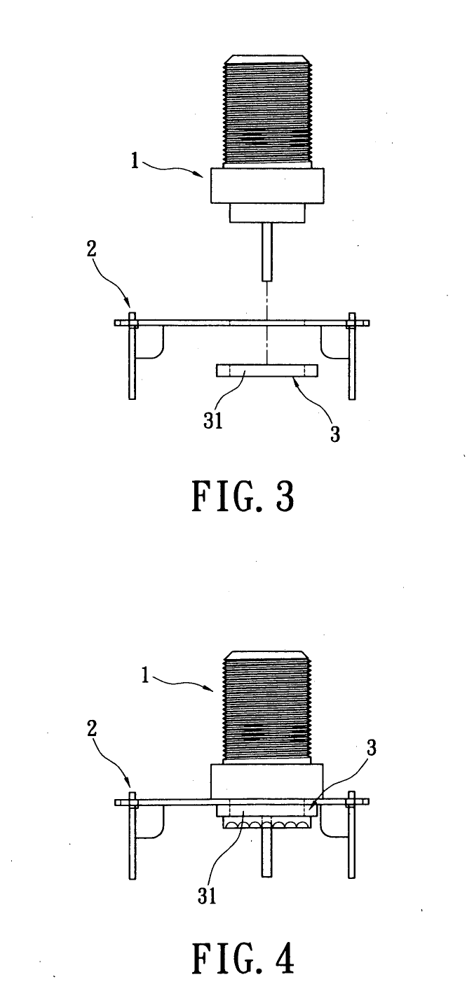

The conducting gasket 31 is located and conducted at the connection area of the communication connector 1 and the enclosure 2. Furthermore, the conducting gasket 31 can be installed at the outer side of the enclosure 2 (as shown in FIGS. 1 and 2), or the inner side of the enclosure 2 (as shown in FIGS. 3 and 4) depending on the requirements and the efficiency.

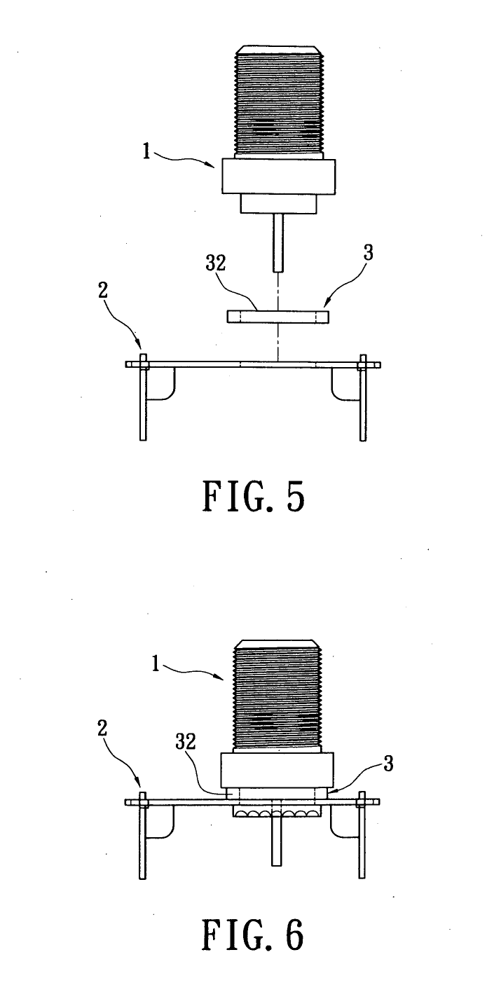

Reference is made to FIGS. 5 and 6. In this embodiment, the conducting element 3 is a non-sticky conducting gasket 32. The conducting gasket 32 is a conductive metal or material, is formed by an injection way with a metal or with a plastic injection mold and equipment. The conducting gasket 32 is located and conducted at the connection area of the communication connector 1 and the enclosure 2. Furthermore, the conducting gasket 32 can be installed at the outer side of the enclosure 2 (as shown in FIGS. 5 and 6), or the inner side of the enclosure 2 depending on the requirements and the efficiency.

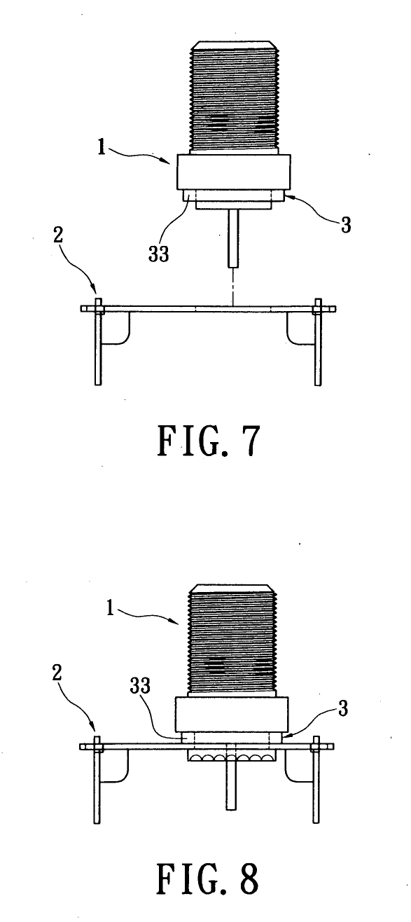

Reference is made to FIGS. 7 and 8. In this embodiment, the conducting element 3 is a sticky conducting gasket 33. The conductive gasket 33 is a conductive metal or material and is sticky. The shape of the raw material can be flake-shaped, strip-shaped, board-shaped, roll-shaped, etc. The raw material is formed into a conductive gasket 33 by using a forming tool (traditional, airing, or pressuring), a slide forming or a rolling-knife punching tool, and a forming mold.

Firstly, the sticky conducting gasket 33 is pasted on the contacting location of the communication connector 1 or the enclosure 2, such as on the inner side, outer side of the enclosure 2, or on the communication 1 (as shown in FIGS. 7 and 8). Next, the communication connector 1 and the enclosure 2 are assembled so that the conducting gasket 33 is located and conducted at the connection area of the communication connector 1 and the enclosure 2.

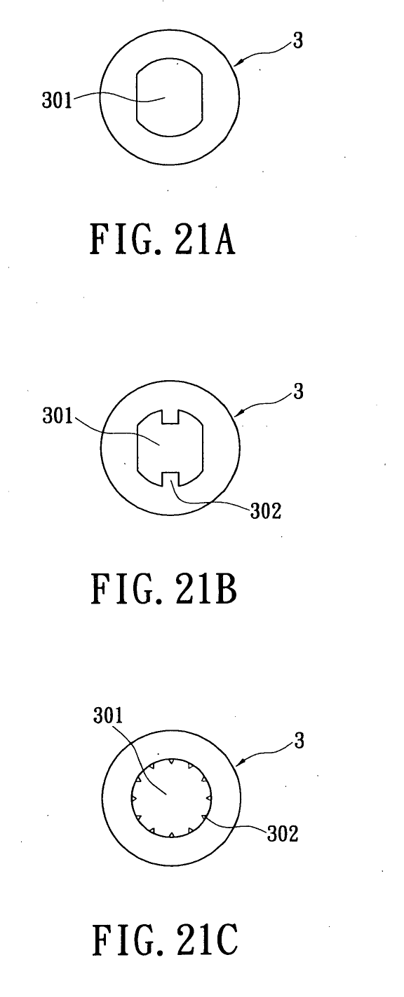

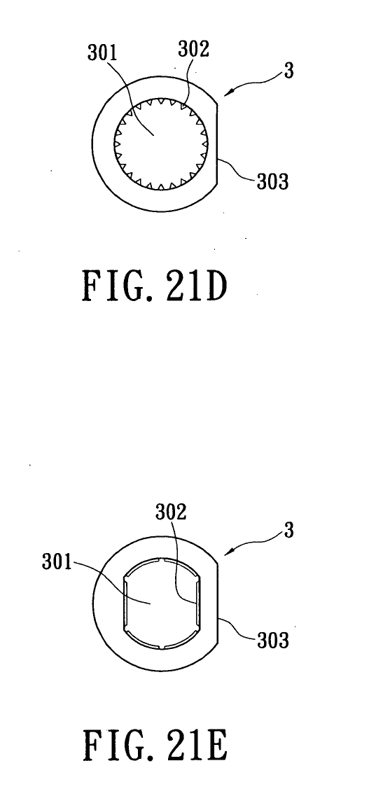

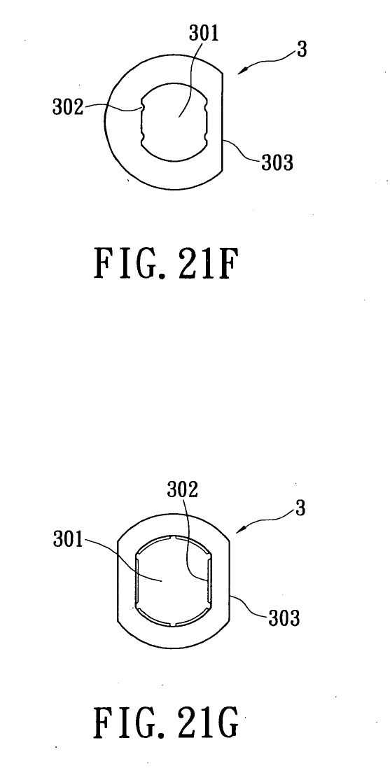

Reference is made to FIGS. 21A˜21G. In this embodiment, the conducting element 3 (such as conducting gasket) has a through hole 301, and used for being sleeved onto the communication connector 1. At the through hole 301 of the conducting element 3, a convex structure 302 is formed by the punching, bending, or drawing way to improve the assembling process, and compensating the gap between the outer diameter of the communication connector 1 and the hole of the enclosure 2. Thereby, the contact area of the communication connector 1 and the enclosure 2 is increased to improve the conductivity and lower the voltage difference. The tiny convex, bent, and drawing structure that has been respectively formed by the punching, bending, and drawing way also has the positioning function to make the assembly process be easier and improve the production efficiency. However, the main function of the convex structure 302 is to increase the contact area of the communication connector 1 and the enclosure 2, especially to increase the contact area of the communication connector 1 and the hole of the enclosure 2. The conducting element 3 also has a positioning portion 303 for positioning the conducting element 3 onto the communication connector 1 or the enclosure 2.

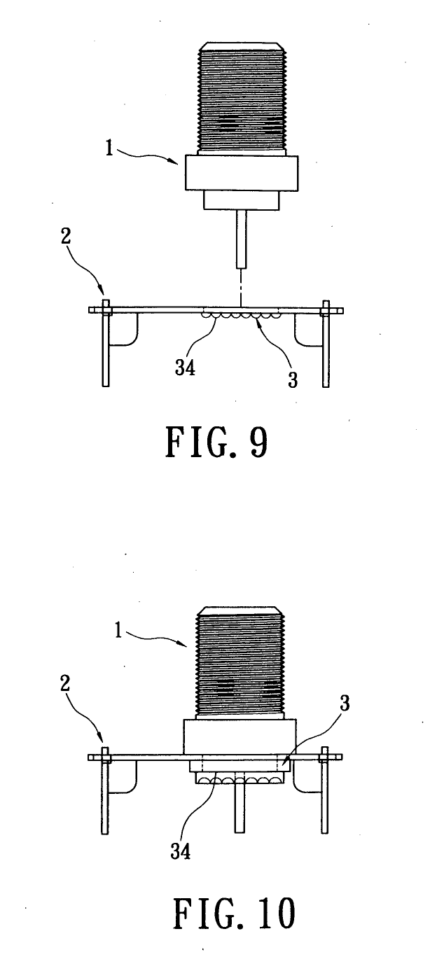

Reference is made to FIGS. 9 and 10. In this embodiment, the conducting element 3 is a conducting glue 34. Before the conducting glue is used, it is liquid, semi-solid, gel, or cream. The conducting glue 34 is a conductive metal or material, and uses the liquid, semi-solid, gel, or cream material as the raw material. By using a glue-spotting tool, the semi-solid conductive material is coated or pasted onto the contact area of the communication connector 1 or the enclosure 2, such as on the inner side (as shown in FIGS. 9 and 10), the outer side of the enclosure 2, or on the communication 1. Next, the communication connector 1 and the enclosure 2 are assembled so that the conducting glue 34 is located and conducted at the connection area of the communication connector 1 and the enclosure 2. In this embodiment, the assembly process can be changed. After the communication connector 1 and the enclosure 2 are assembled, the semi-solid conductive material is coated or pasted onto the contact area of the communication connector 1 or the enclosure 2, such as on the inner side (as shown in FIGS. 9 and 10), the outer side of the enclosure 2, or on the communication 1.

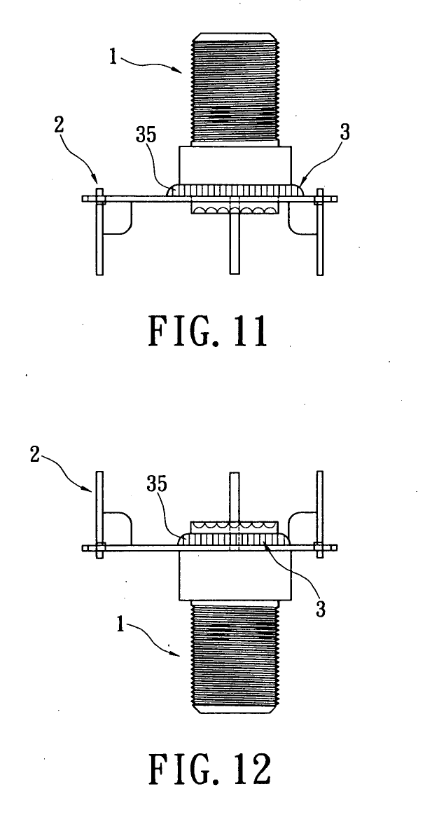

Reference is made to FIGS. 11 and 12. In this embodiment, the conducting element 3 is a formed tin-ring 35. The tin-ring 35 uses material such as tin-strip, tin-flake, or tin-rod with flux as the raw material and the tin ring 35 is formed with a proper shape and dimension by the winding machine, a forming tool (traditional, airing, or pressuring), a slide forming, a bending machine, or a pressing machine. It is can also be rolled manually.

The tin-ring 35 is located at the connection area of the communication connector 1 and the enclosure 2. Furthermore, the tin-ring 35 can be installed at the outer side of the enclosure 2 (as shown in FIG. 11), or the inner side of the enclosure 2 (as shown in FIG. 12). By using an oven, an electric stove, a soldering stove, or a hand-held heater to melt the tin so that the tin-ring 35 is melted, located and conducted at the connection area of the communication connector 1 and the enclosure 2.

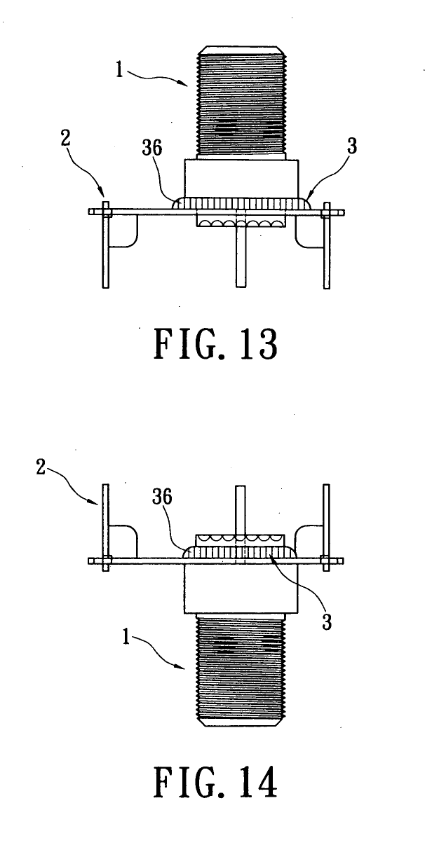

Reference is made to FIGS. 13 and 14. In this embodiment, the conducting element 3 is a tin washer 36. The tin washer 36 is also a tin-ring. The tin washer 36 contains flux or is coated with flux. The tin washer 36 is formed with a tin flake that has a proper dimension by using a winding machine, a forming tool (traditional, airing, or pressuring), a slide forming machine, a bending machine, or pressing machine. It is also can be rolled manually

The tin washer 36 is located at the connection area of the communication connector 1 and the enclosure 2. Furthermore, the tin washer 36 can be installed at the outer side of the enclosure 2 (as shown in FIG. 13), or the inner side of the enclosure 2 (as shown in FIG. 14). By using an oven, an electric stove, a soldering stove, or a hand-held heater to melt the tin so that the tin washer 36 is melted, located and conducted at the connection area of the communication connector 1 and the enclosure 2.

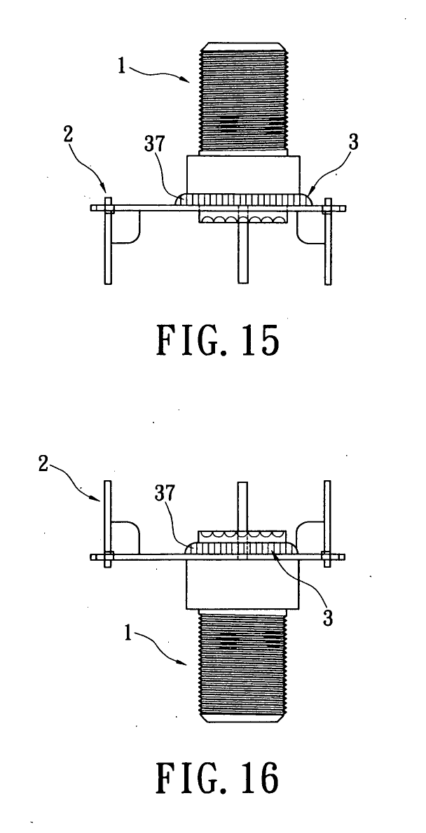

Reference is made to FIGS. 15 and 16. In this embodiment, the conducting element 3 is a tin-ring 37 formed by powder metallurgy or metal injection. The raw material for the tin-ring 37 is tin powder or tin ball. The tin-ring 37 with a proper dimension is manufactured by powder metallurgy or metal injection.

After the tin-ring 37 is coated or filled with flux, the tin-ring 37 is located at the connection area of the communication connector 1 and the enclosure 2. Furthermore, the tin-ring 37 can be installed at the outer side of the enclosure 2 (as shown in FIG. 15), or the inner side of the enclosure 2 (as shown in FIG. 16). By using an oven, an electric stove, a soldering stove, or a hand-held heater to melt the tin so that the tin-ring 37 is melted, located and conducted at the connection area of the communication connector 1 and the enclosure 2.

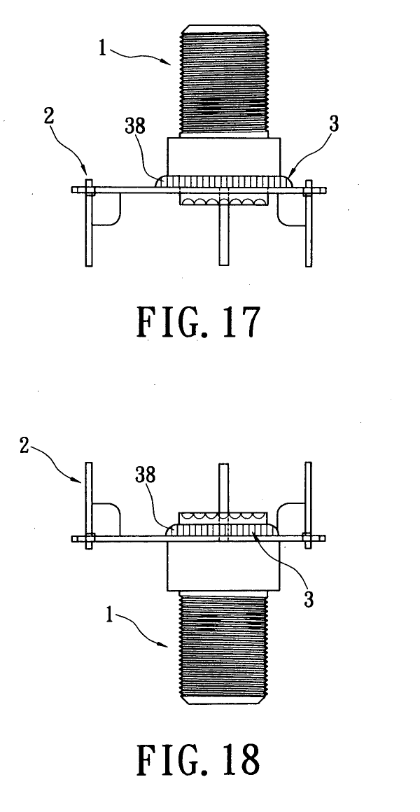

Reference is made to FIGS. 17 and 18. In this embodiment, the conducting element 3 is a tin-ring 38 formed by die-casting or heat-casting. The raw material for die-casting is tin powder, tin ball, or tin ingot. The raw material for heat-casting is tin-strip, tin-flake, or tin ingot. The tin-ring 38 with a proper dimension is manufactured by working process and equipment of die-casting or heat-casting.

After the tin-ring 38 is coated or filled with flux, the tin-ring 38 is located at the connection area of the communication connector 1 and the enclosure 2. Furthermore, the tin-ring 38 can be installed at the outer side of the enclosure 2 (as shown in FIG. 17), or the inner side of the enclosure 2 (as shown in FIG. 18). By using an oven, an electric stove, a soldering stove, or a hand-held heater to melt the tin so that the tin-ring 38 is melted, located and conducted at the connection area of the communication connector 1 and the enclosure 2.

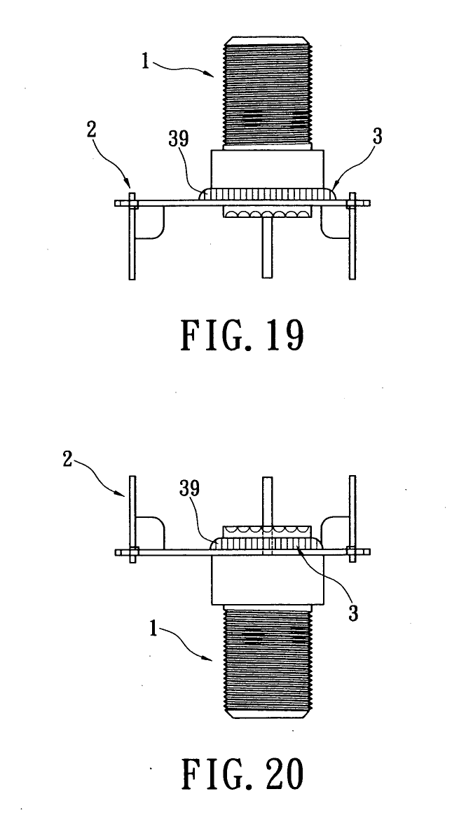

Reference is made to FIGS. 19 and 20. In this embodiment, the conducting element 3 is tin grease 39. The tin grease 39 is coated, attached, pasted, printed, or deposited on the connection area of the communication connector 1 and the enclosure 2. Furthermore, the tin grease 39 can be installed at the outer side of the enclosure 2 (as shown in FIG. 19), or the inner side of the enclosure 2 (as shown in FIG. 20). The quantity of the tin grease for each point, the number, and the location of the points can be determined by the requirements. An oven, an electric stove, a soldering stove, or a hand-held heater is used for heating and melting the tin.

The present invention has the following characteristics:

1. The structure for improving the voltage difference of a connector of the present invention is not implemented by the manual soldering way so as to increase the conductivity of the communication connector and the enclosure to improve the voltage difference. The manufacturing time and cost are reduced.

2. The structure for improving the voltage difference of a connector of the present invention can be applied to a variety of communication connector (socket), such as an F connector manufactured by turning or free-cutting, a PAL connector manufactured by turning, free-cutting, pipe-cutting, or deep-drawing, or other connector. The voltage difference is improved.

The description above only illustrates specific embodiments and examples of the present invention. The present invention should therefore cover various modifications and variations made to the herein-described structure and operations of the present invention, provided they fall within the scope of the present invention as defined in the following appended claims.

1. A structure for improving the voltage difference of a connector, comprising:
a communication connector;
an enclosure, wherein the communication connector is assembled with the enclosure; and
a conducting gasket, wherein the conducting gasket is located and conducted at the connection area of the communication connector and the enclosure.

2. The structure for improving the voltage difference of a connector as claimed in claim 1, wherein the conducting gasket has a through hole, and the through hole is sleeved onto the communication connector.

3. The structure for improving the voltage difference of a connector as claimed in claim 2, wherein a convex structure is located at the through hole, and the convex structure fills the gap between the communication connector and the enclosure.

4. The structure for improving the voltage difference of a connector as claimed in claim 1, wherein the conducting gasket has a positioning portion, and the positioning portion is positioned on the communication connector or the enclosure.

5. The structure for improving the voltage difference of a connector as claimed in claim 1, wherein the conducting gasket is installed at outer side or inner side of the enclosure.

6. The structure for improving the voltage difference of a connector as claimed in claim 1, wherein the conducting gasket is non-sticky or sticky.

7. The structure for improving the voltage difference of a connector as claimed in claim 1, wherein the conducting gasket is a conductive metal or a conductive material.

8. A structure for improving the voltage difference of a connector, comprising:
a communication connector;
an enclosure, wherein the communication connector is assembled with the enclosure; and
a tin-ring, wherein the tin-ring is located and conducted at the connection area of the communication connector and the enclosure.

9. The structure for improving the voltage difference of a connector as claimed in claim 8, wherein the tin-ring is installed at outer side or inner side of the enclosure.

10. The structure for improving the voltage difference of a connector as claimed in claim 8, wherein the tin-ring uses an oven, an electric stove, a soldering stove, or a hand-held heater to melt the tin.

11. The structure for improving the voltage difference of a connector as claimed in claim 8, wherein the tin-ring is formed by tin-strip, tin-flake, or tin-rod.

12. The structure for improving the voltage difference of a connector as claimed in claim 8, wherein the tin-ring is formed by powder metallurgy, metal injection, casting, die-casting, or heat-casting.

13. The structure for improving the voltage difference of a connector as claimed in claim 8, wherein the tin-ring is a tin-flake washer.

14. A structure for improving the voltage difference of a connector, comprising:
a communication connector;
an enclosure, wherein the communication connector is assembled with the enclosure; and
a conductive glue, wherein the conductive glue is located and conducted at the connection area of the communication connector and the enclosure.

15. The structure for improving the voltage difference of a connector as claimed in claim 14, wherein the conductive glue is installed at outer side or inner side of the enclosure.

16. The structure for improving the voltage difference of a connector as claimed in claim 14, wherein the conductive glue is liquid, semi-solid, gel, or cream.

17. A structure for improving the voltage difference of a connector, comprising:
a communication connector;
an enclosure, wherein the communication connector is assembled with the enclosure; and
a tin grease, wherein the tin grease is located and conducted at the connection area of the communication connector and the enclosure, and an oven, an electric stove, a soldering stove, or a hand-held heater is used for heating and melting the tin so that the tin grease is conducted at the connection area of the communication connector and the enclosure.

18. The structure for improving the voltage difference of a connector as claimed in claim 17, wherein the tin grease is installed at outer side or inner side of the enclosure.

19. The structure for improving the voltage difference of a connector as claimed in claim 17, wherein the tin grease coated, attached, pasted, printed, or disposed on the connection area of the communication connector and the enclosure.
